(19) United States
(12) Patent Application Publication
(10) Pub. No.: US 2007/0119886 A1
(43) Pub. Date: May 31, 2007

(54) VEHICLE ARTICLE CARRIER HAVING STOWABLE CROSS BARS AND BUILT-IN STOWAGE SPACE FOR ACCESSORY ITEMS

(76) Inventors: Robert C. Jablonski, Rochester Hills, MI (US); Milton J. Antonick, Royal Oak, MI (US); Gerard J. Kmita, Allen Park, MI (US); Claude Trambley, Macomb, MI (US); Donald L. Munoz, Bloomfield Hills, MI (US); Julius J. Cassani, Troy, MI (US); Noel V. Ranka, Canton, MI (US)

Correspondence Address: HARNESS, DICKEY & PIERCE, P.L.C., P.O. BOX 828, BLOOMFIELD HILLS, MI, 48303, US

(21) Appl. No.: 11/552,162

(22) Filed: Oct. 24, 2006

Related U.S. Application Data
(60) Provisional application No. 60/731,841, filed on Oct. 31, 2005.

(51) Int. Cl. B60R 9/042

(52) U.S. Cl. 224/310

(57) ABSTRACT

An article carrier system for use on a roof of a motor vehicle such as a pick-up truck. The system includes a housing within which cross bar components may be stowed when not in use, and which also includes one or more stowage compartments or stowage bins for stowing vehicle article carrier accessories. In one embodiment the cross bar components are detached from the housing and reattached to the housing such that they extend width-wise along the roof of the vehicle. In another embodiment, the cross bar components are pivotally supported and may be pivoted between stowed and deployed positions. A removable cover allows the cross bar components to be locked within the housing.

### CROSS-REFERENCE TO RELATED APPLICATIONS

This application claims the benefit of provisional application U.S. Ser. No. 60/731,841, filed Oct. 31, 2005. The disclosure of the above application is incorporated herein by reference.

### FIELD OF THE INVENTION

The present invention is generally related to vehicle article carriers, and more particularly to a vehicle article carrier system adapted to be secured to a roof portion of a vehicle, and which enables a pair of cross bars to be moved between stowed and deployed positions, and which further includes an internal stowage compartment for stowing article carrier accessories such as ski racks, bicycle racks, etc.

### BACKGROUND OF THE INVENTION

Vehicle article carriers are used in a wide variety of applications to assist in supporting and securing variously shaped articles to exterior surfaces of motor vehicles such as cars, trucks, vans, SUVs, etc. Often, such vehicle article carriers make use of a pair of cross bars that are supported above an outer body surface of the vehicle on a corresponding pair of side rails. The side rails are typically fixedly secured to the roof of the vehicle and arranged along the major longitudinal length of the vehicle, and parallel to one another. The opposite ends of each cross bar are supported by the side rails, and the cross bars can be secured at desired positions along the side rails.

While the foregoing-described vehicle article carrier system has proven to be extremely useful and effective for securing and transporting variously sized articles, in some instances it would be desirable to be able to place the cross bars in a stowed position when they are not in use. It would also be desirable if a vehicle article carrier could be constructed that does not require the use of conventional side rails for supporting the cross bars at their opposite ends. Still further, it would be highly desirable to provide a vehicle article carrier that includes a stowage compartment for stowing accessories that are often used with a vehicle article carrier, for example, a ski rack, a bicycle rack, etc., in a secure manner, such that theft of such accessories is not a concern when the accessories are being stowed.

It would also be highly desirable to provide a vehicle article carrier that enabled the above advantages to be realized, and yet which is aerodynamically shaped, and aesthetically adds to the appeal of the vehicle with which it is used.

### SUMMARY OF THE INVENTION

The present invention is related to a vehicle article carrier system especially well adapted to be mounted on the roof portion of a vehicle such as a pick-up truck, a van, SUV, station wagon sedan, etc. In one preferred embodiment the apparatus includes an aerodynamically shaped housing that is secured to a roof portion of the vehicle. The housing enables a pair of cross bars to be secured thereto in stowed or deployed positions. The housing also includes a removable cover and also defines an interior compartment. The interior compartment includes sufficient space for stowing a pair of cross bars in a secure manner, as well as additional areas for stowing article carrier accessories such as a ski rack, a bicycle rack, tie down cords, etc.

In a preferred embodiment the housing also includes at least one forwardly facing light which can be turned on and off from an interior of the vehicle with which the vehicle article carrier system is used.

In a preferred embodiment, the housing also includes scalloped areas through which the cross bars can project when the cross bars are secured in their deployed positions. In their deployed positions, each cross bar is supported by the housing generally perpendicular to the housing and above the roof surface of the vehicle. The housing may include a sufficient plurality of scalloped areas to enable at least one of the cross bars to be placed in two or more distinct positions. This enables a degree of adjustable spacing between the two cross bars when the cross bars are in their deployed positions.

In preferred embodiments, each cross bar further includes at least a pair of manually engageable locking members that can be used to secure the cross bar in either its stowed position or its deployed position. The cross bars can easily be moved between the stowed and deployed positions in merely a matter of minutes by a single individual, and without any special tools or complicated disassembly procedures.

The removable cover of the housing may be hinged at one end, or may be simply secured via a tongue and groove at one end of the cover. A key actuated locking element is incorporated to allow the cover to be locked to the housing, thus preventing unauthorized access into the interior of the vehicle article carrier system. When the cover is locked on the housing, the locking members that are used to secure the cross bars to the housing are also enclosed within the housing, and therefore not accessible. This eliminates the possibility that the cross bars could be stolen or otherwise tampered with.

In an alternative preferred embodiment a vehicle article carrier is included which makes use of a housing having two pairs of cross bar components. A first pair of the cross bar components each has an L-shaped end and each is pivotally secured to interior structure of the housing. Each one of the first pair of cross bar components may be pivoted between stowed and operative positions. In their operative positions, the first pair of cross bar components each project outwardly perpendicular to the housing, and width-wise along the roof surface of the vehicle on which the housing is mounted, A second pair of cross bar components is also pivotally mounted within the housing along a corresponding pair of slats. Each of the slats form channels that allow the cross bar pivotally secured to it to be moved longitudinally along the slat and secured at a desired position along the slat. Each of the cross bar components also includes a locking member that allows an individual to manually secure it in a stowed or deployed position. The locking members of the second pair of cross bar components also permit the second pair of cross bar components to be secured at desired longitudinal positions along the slats. When the second pair of cross bar components are not needed, they can be pivoted into positions overlaying their respective slats and their respective locking members tightened to secure each in a stowed position. This embodiment also includes a storage compartment within the housing for storing article carrier accessories such as a ski rack, a bicycle rack, tie down cords, etc.

The various preferred embodiments herein all provide an aerodynamic vehicle article carrier system that allows for a pair of cross bars to be moved between stowed and deployed conditions, as well as to provide an internal stowage area that can be secured with a locked cover portion. The various preferred embodiments are all aesthetically appealing and enhance the appearance of the vehicle on which the vehicle article carrier is used.

Further areas of applicability of the present invention will become apparent from the detailed description provided hereinafter. It should be understood that the detailed description and specific examples, while indicating various preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a roof portion of a vehicle including a preferred embodiment of the vehicle article carrier system of the present invention mounted thereon;

FIG. 2 is the same view of the vehicle article carrier system of FIG. 1, but with a removable cover portion of the system removed, and with the cross bars in stowed positions supported within the housing;

FIG. 3 is a perspective view of the cross bars of the article carrier system of FIG. 1 in their deployed positions, with the cover of the housing removed;

FIG. 4 is a top view of an alternative preferred vehicle article carrier system in which the cross bar members are supported for pivotal movement between stowed and deployed positions, and wherein a rear pair of the cross bar members can also be slidably positioned along a pair of support slats when in their deployed positions;

FIG. 5 is yet another alternative preferred embodiment of the present invention in which the cover member of the housing is pivotally mounted along a longitudinal center line such that the cover forms two longitudinally extending half portions when opened; and

FIG. 6 is a front view of the system of FIG. 5 showing the two halves of the cover in their opened positions,

### DETAILED DESCRIPTION OF THE PREFERRED EMBODIMENTS

The following description of the preferred embodiment(s) is merely exemplary in nature and is in no way intended to limit the invention, its application, or uses.

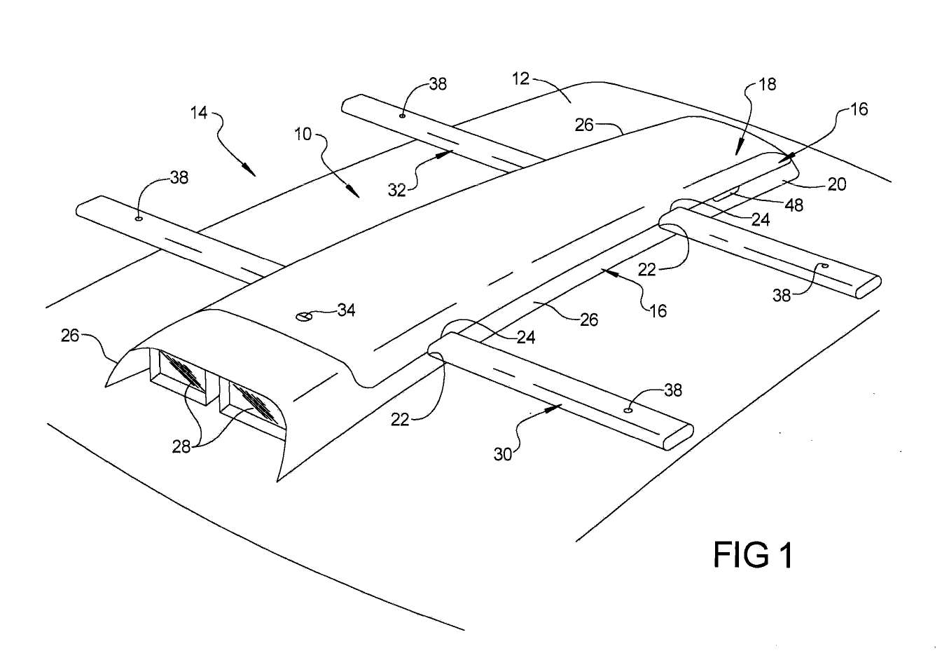

Referring to FIG. 1, a vehicle article carrier system 10 in accordance with a preferred embodiment of the present invention is illustrated mounted on a roof portion 12 of a motor vehicle 14. The motor vehicle 14 may comprise a pick-up truck, van, SUV, station wagon sedan or any other motor vehicle having a roof portion where it is desired to support articles above the roof portion. While the present invention is not limited to use with any one specific type of vehicle, it is anticipated that the system 10 will find particular utility with pick-up trucks in which access to the roof portion may be had most easily by standing in the bed portion of the vehicle.

The system 10 comprises an aerodynamically shaped housing 16 having a cover portion 18. The housing 16 includes opposing side walls 20 each having scalloped portions 22. The cover 18 also includes scalloped portions 24 on opposing side walls 26. The housing 16 also optionally includes one or more lights 28 which may be wired into the vehicle's electrical system and turned on and off from a light switch inside the passenger compartment of the vehicle 14.

The system 10 further includes a first elongated, tubular cross bar 30 and a second elongated tubular cross bar 32. When in the deployed positions, the cross bars 30 extend width-wise along the roof 12 of the vehicle 14, while the housing 16 extends longitudinally along the roof, and is preferably aligned over the center of the roof 12. When the cross bars 30, 32 are in their deployed positions shown in FIG. 1, vehicle article carrier accessories, such as a ski rack, a bicycle rack, etc., can be secured to the cross bars 30 and 32 via conventional clamps or other forms of coupling elements. The cross bars 30 and 32 are preferably made from aluminum or any other suitably strong material. The cross bars 30 and 32 may be roll formed, extruded or constructed in accordance with any other construction technique that may be used to form tubular, elongated components. Optionally, the cross bars 30 and 32 could include channels formed therein for allowing threaded fastening components to be inserted in the channels and used to assist in securing external article carrier accessories to the cross bars 30 and 32.

With further reference to FIG. 1, when in the deployed position, and with the cover 18 attached to the housing 16, the cross bars 30 and 32 are in effect captured between the housing 16 and the cover 18. The cover 18 may include a key actuated lock 34 at one end or the other for locking the cover to the housing 16. The cover 18 may secure to the housing 16 via a tongue portion (not shown) at the end opposite that which includes the lock 34, in which the tongue portion engages a notch (not shown) in the housing 16. Alternatively, the cover 18 may be pivotally hinged at one end, in this example the end opposite the lock 34. Also, one or more pneumatic telescoping assemblies could be used to help hold the cover 18 in a raised position while the cross bars 30, 32 are being moved between stowed and deployed positions on the housing 16.

When the cover 18 is locked to the housing 16, removal of the cross bars 30 and 32, or tampering with the cross bars, is not possible. With the cover 18 secured to the housing 16, the system 10 provides an aesthetically pleasing appearance that enhances the overall appearance of the vehicle. The housing 16 and cover 18 are preferably made from high strength plastic and may be molded or manufactured in accordance with any other manufacturing technique suitable for working with high strength plastics. The housing 16 may be secured to the outer body surface of the vehicle 16 via conventional riv nuts or by any suitable means for fastening an article carrier system to a vehicle roof.

With further reference to FIG. 1 it will be noted that when the cross bars 30 and 32 are in their deployed positions, each extends above the roof surface 12 by a small amount. The outermost ends of each cross bar 30 and 32 are further not supported by any other article carrier structure. Thus, the use of slats or side rails, which are commonly used in vehicle article carrier systems to support the outermost ends of the cross bars, are not required with the present invention.

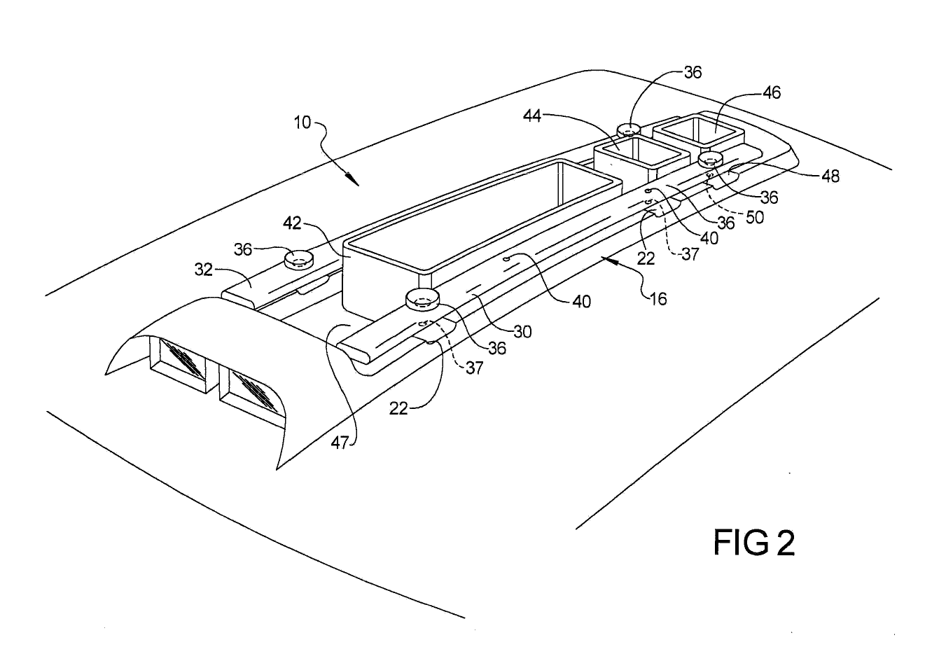

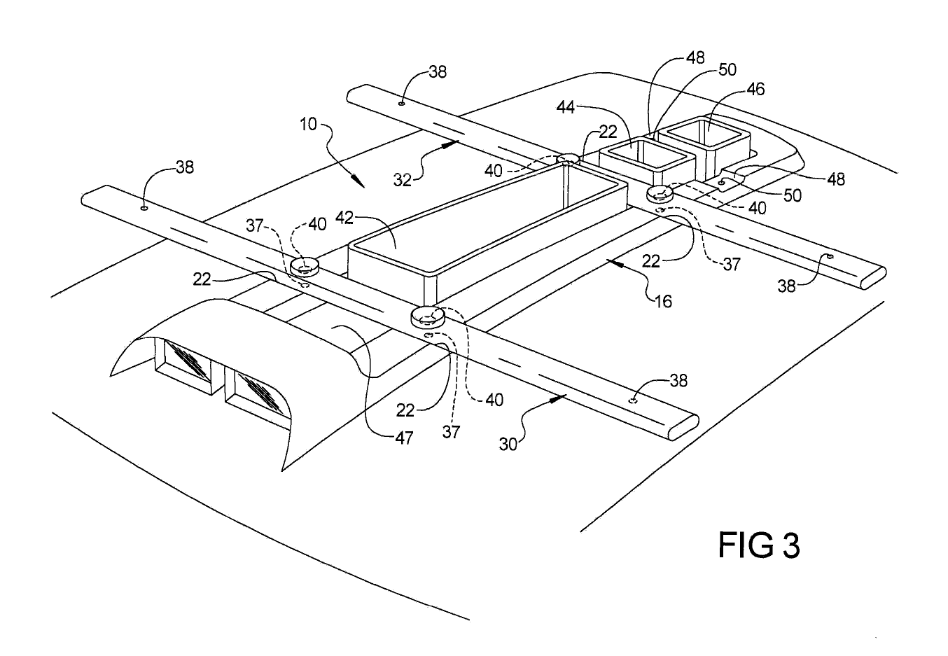

Referring to FIG. 2, the system is shown with the cover 18 removed and the cross bars 30 and 32 stowed within the housing 16. The cross bars 30 and 32 may be stowed by manual locking members that form graspable wheels 36. The wheels 36 have threaded shafts (not shown) that engage with threaded openings (not shown) in the housing 16 to secure each cross bar 30 and 32 to the housing 16. When the cross bars 30 and 32 are needed for use, a user merely rotates each of the locking wheels 36 counterclockwise to unthread them from the threaded openings (i.e., bores) in the housing 16, and remove them from a first pair of openings 38 in each cross bar 30, 32. The cross bars 30 and 32 are then removed from their stowed positions and laid in the scalloped areas 22, as shown in FIG. 3. The locking wheel members 36 are then repositioned over the cross bars 30 and 32 and their threaded shafts reinserted through different pairs of holes 40 in the cross bars, and then into the threaded bores in the housing 16. Thus, each cross bar 30, 32 includes the first pair of openings 38 which are used to secure the cross bars 30, 32 for stowage, and the second pair of openings 40 that enable the cross bars 30, 32 to be fixedly secured to the housing 16 in their deployed positions.

With further reference to FIGS. 2 and 3, a principal advantage of the system 10 is that the housing 16 includes a plurality of areas or bins 42, 44 and 46 for storing article carrier accessories such as a ski rack, a bicycle rack, tie down cords, wet or soiled clothing items or any other accessory that may be used with the cross bars 30 and 32. The height of each of the containers 42, 44 and 46 is such that they do not interfere, when placed in the housing 16, with attachment of the cover 18 to the housing 16. The bins 42, 44 and 46 may be integrally formed from high strength plastic and include a weather seal so as to extend upwardly from a bottom wall 47 (FIG. 3) of the housing 16, or alternatively formed as separate components that fit nestibly within the housing 16, and rest on the bottom wall 16, and between the cross bars 30 and 32.

With further reference to FIGS. 2 and 3, the housing 16 may include an additional pair of scalloped areas 48, together with threaded bores 50, that enable cross bar 32 to be positioned in one of two positions. Thus, this allows the spacing between the cross bars 30 and 32 to be changed if needed.

Since the system 10 allows for the cross bars 30 and 32 to be stowed within the housing 16 when not in use, the system 10 eliminates the possibility of the cross bars 30 and 32 causing wind noise when they are not in use. The system 10 also provides an aesthetically clean appearance to the roof area 12 of the vehicle 14. The locking wheel members 40 do not require any special tools, and can be loosened and tightened simply by hand, thus making positioning of the cross bars 30 and 32 between stowed and deployed positions a quick, easy task for an individual to complete.

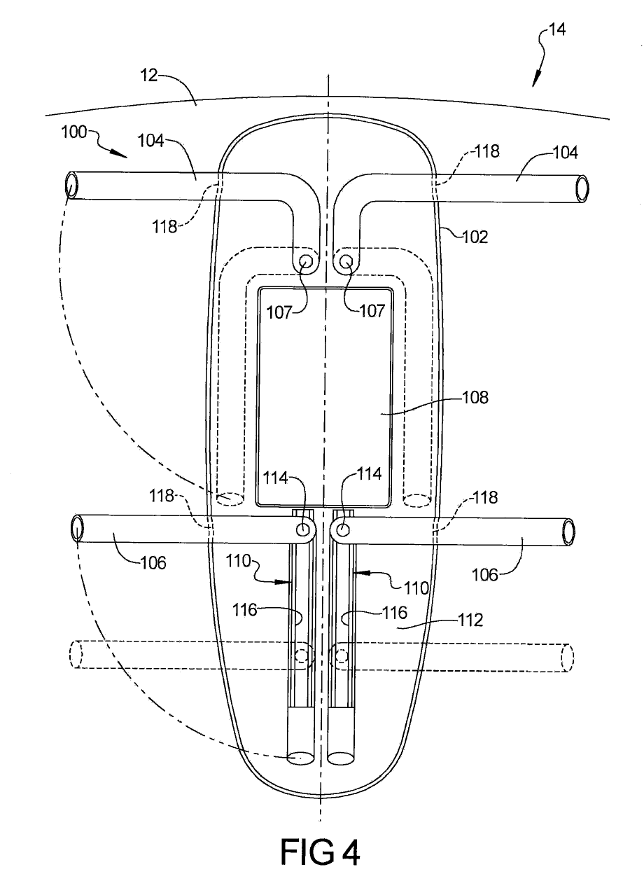

Referring to FIG. 4, a vehicle article carrier system 100 is shown in accordance with an alternative preferred embodiment of the present invention. System 100 is also secured in any conventional fashion to the roof portion 12 of a motor vehicle 14 such as a pick-up truck, SUV, station wagon sedan, or any other vehicle having a roof portion where it is desired to support articles elevationally above the roof portion.

The system 100 similarly includes a housing 102. For purposes of clarity, the cover portion that would cover the housing 102 is not shown to better illustrate the internal structure of the system 100. The housing 102 includes a first pair of pivotally mounted cross bar members 104 and a second pair of pivotally mounted cross bar members 106. Cross bar members 104 each have a manually engageable locking wheel member 107, preferably identical in construction to locking member 36, that can be tightened down to secure each cross bar component 104 in either its deployed position, as shown in solid lines in FIG. 4, or its stowed position, as shown in dashed lines. A central stowage area or stowage bin 108 is included for stowing vehicle article carrier accessories.

With further reference to FIG. 4, the cross bar components 106 are also pivotally mounted to slat components 110. Slat components 110 may be secured directly to the outer body surface of the vehicle 14 provided cutouts are formed in a bottom wall 112 of the housing 102, or they may be secured directly to the bottom wall 112. Manually engageable locking wheel members 114 may be similar or identical in construction to locking members 36, and can be used to secure the cross bar components 106 in their deployed position, shown in solid lines, or in their stowed positions, in which they would lay parallel to, and directly over, the slats 110. The slats 110, preferably are each formed to include a channel 116. The locking members 114, when loosened, allow each of the cross bar components 106 to be moved longitudinally along their respective slats 116 to a desired position, and then retightened at the desired position. Accordingly, the slats 116 provide the cross bars 106 with a degree of adjustability in their respective spacings from the cross bar components 104. The cross bar components 106 are shown in dashed lines at an auxiliary position, rearwardly of the position shown in solid lines. The cross bar components 104, 106 are preferably of tubular aluminum construction, but may be made from any suitably strong materials that are also weather resistant.

The system 100 thus allows the cross bar components 104, 106 to be moved between stowed positions and deployed positions without any external tools, and without completely detaching any of the cross bar components 104 or 106 from the housing 102. When the cross bar components 104 and 106 are in either of their deployed or stowed positions, a cover, such as cover 18, may be secured to the housing 102 to provide an aerodynamically and aesthetically pleasing appearance to the system 100. As with the housing 16, scalloped areas 118 help to support the cross bar components 104, 106.

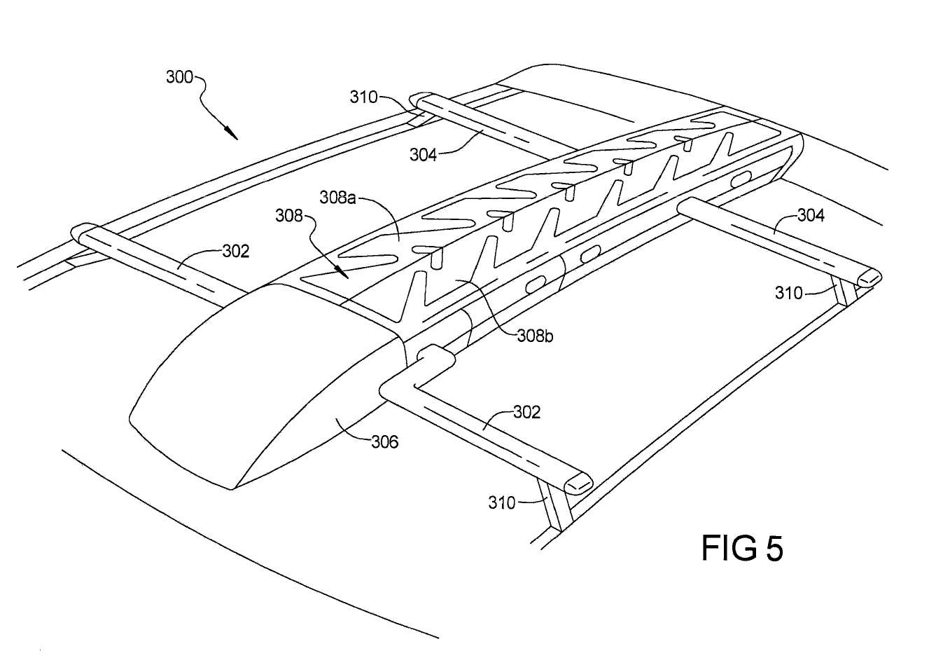

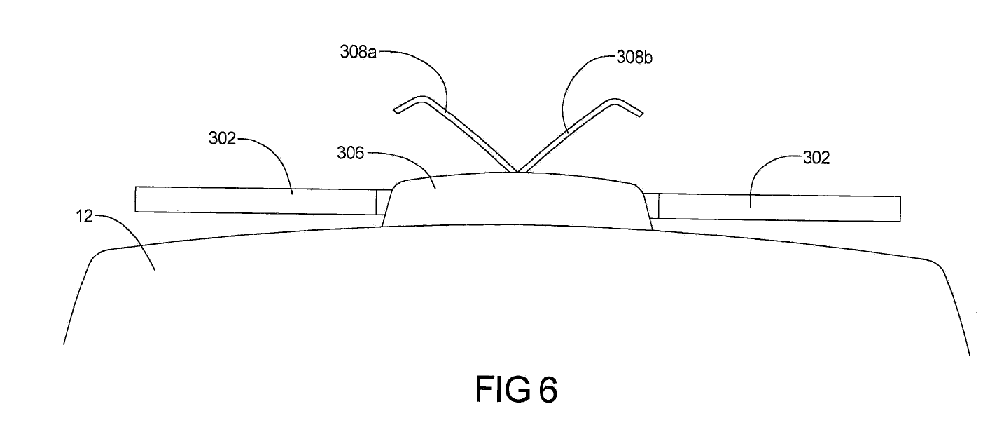

Referring to FIG. 5, an article carrier system 300 in accordance with another alternative preferred embodiment of the present invention is shown. Article carrier system 300 is similar to system 100 in that it incorporates pivotally supported cross bar components 302 and 304 that project from, and are secured to, a housing 306. However, this embodiment has a cover 308 which is made up of two longitudinally extending sections 308a and 308b. The cover 308 is hinged along its longitudinal centerline such that portions 308a and 308b may be lifted upwardly away from the housing 306 (FIG. 6), when it is necessary to move the cross bar components 302 and 304 from stowed to deployed positions or from deployed to stowed positions. Thus, there is no need to remove the entire cover 308 from the housing 16 when the cross bar components 302 and 304 are moved between stowed and deployed positions. The cover portions 308a and 308b are shown in their unlocked (raised) positions in FIG. 6.

With further reference to FIG. 5, the system 300 makes use of support elements 310 which may rest on an outer body surface, or which may be securable to a rain gutter of the roof 12 of the vehicle 14. Supports 310 are optional, but serve to increase the capacity of the cross bar components 302 and 304 should articles be positioned towards the outermost edges of each of the components 302 and 304.

The various preferred embodiments all enable the cross bar components of an article carrier assembly to be positioned within an enclosed housing, or deployed into extended positions for use when needed. When stowed, the various preferred embodiments of the article carrier system each form an aesthetically pleasing, aerodynamically efficient system. The internal stowage areas provide a convenient space for stowing article carrier accessories in a secure manner. Advantageously, certain of the preferred embodiments described herein do not require conventional side rails to be secured to the outer body surface of a vehicle to support the cross bar components.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle article carrier system for use with a motor vehicle having an outer body surface, the article carrier system comprising:
a housing secured to said outer body surface, the housing having at least one first pair of scalloped openings formed on opposing sidewall portions of the housing along an edge of the housing;
a cover having an edge, said edge having a second pair of scalloped openings spaced in accordance with a spacing of said first pair of scalloped openings to define a pair of fully formed openings when said cover is secured to said housing; and
a cross bar member having:
an operative configuration in which said cross bar member is positioned within said fully formed openings so as to extend from, and be held securely by, said housing and said cover when said housing and said cover are secured together, said opposing end portions of said cross bar projecting from said opposing sidewall portions to thus enable articles to be supported on said cross bar member; and
a stowed configuration in which said cross bar member is positioned entirely within said housing and said cover is secured to said housing.
